(19) United States
(12) Patent Application Publication
(10) Pub. No.: US 2003/0166760 A1
(43) Pub. Date: Sep. 4, 2003

(54) Polymeric blends and composites and laminates thereof

(76) Inventors: Donald W. Taylor, Liberty, MO (US); James W. Freitag, Kearney, MO (US)

Correspondence Address: ORSCHELN MANAGEMENT CO, 2000 US HWY 63 SOUTH, MOBERLY, MO, 65270, US

(21) Appl. No.: 10/375,555

(22) Filed: Feb. 26, 2003

Related U.S. Application Data
(63) Continuation of application No. 09/776,362, filed on Feb. 2, 2001.
(60) Provisional application No. 60/179,846, filed on Feb. 2, 2000.
(60) Provisional application No. 60/192,285, filed on Mar. 27, 2000.
(60) Provisional application No. 60/205,509, filed on May 19, 2000.
(60) Provisional application No. 60/237,269, filed on Oct. 2, 2000.

(51) Int. Cl. C08L 1/00

(52) U.S. Cl. 524/442

(57) ABSTRACT

The disclosure relates to polymeric blends comprising at least one polymer, at least one resin, at least one filler or corrosion reducing material, among other components. The blend can be fabricated into a virtually unlimited array of shapes such as extruded tapes, cast as sheets or films, sealants such as gaskets and caulks, extruded or shaped profiles, stamped, among other configurations.

The subject matter herein claims benefit under 35 U.S.C. 119(e) of U.S. Patent Application Serial Nos. 60/179,846, filed on Feb. 2, 2000, 60/192,285, filed on Mar. 27, 2000, 60/205,509, filed on May 19, 2000 and 60/237,269, filed on Oct. 2, 2000, in the name of Donald W. Taylor et al. The disclosure of each of the previously identified patent applications is hereby incorporated by reference.

### FIELD OF THE INVENTION

The subject matter of the invention relates to the field of tapes, sheets, wraps, greases and other polymeric blends.

### BACKGROUND OF THE INVENTION

It is known in the art to use protective wrapping materials for reducing corrosion rate of metallic conduits such as pipes, tubes and flanges. Conventional practice for protecting underground pipes from corrosion employs bituminous materials such as coal-tar or asphalts, wax, among other materials, e.g., refer to U.S. Pat. No. 4,039,706 (Tajima et al.), U.S. Pat. No. 4,572,868 (Hosaka et al.), U.S. Pat. No. 4,600,635 (Wiercinski et al.), U.S. Pat. No. 4,789,578 (Twyford et al.), U.S. Pat. No. 4,983,449 (Nee), U.S. Pat. No. 5,120,381 (Nee), U.S. Pat. No. 5,814,172 (Cox et al.) and U.S. Pat. No. 6,034,002 (Maderek). The disclosure of these patents is hereby incorporated by reference. While these materials are effective to provide corrosion resistance, there is a need in this art for a corrosion protectant that is easier to apply, environmentally acceptable and effective.

### SUMMARY OF THE INVENTION

The instant invention solves problems associated with conventional practice by providing a protective polymeric blend that can be applied upon a metal containing surface such as a pipe without first applying a primer, has minimal surface preparation, no primer, hand surface preparation, the capability to apply over sweating pipe, and requires minimal clean-up, e.g, solvent free or environmentally benign cleaners. The inventive blend can also be applied upon a pipe having an elevated temperature, or water condensing upon its surface. The ability to-solve such problems is a marked improvement over conventional practices.

### DETAILED DESCRIPTION

Broadly, the instant invention relates to polymeric blends comprising at least two polymers, at least one resin, at least one filler or corrosion reducing material, among other components. The blend can be fabricated into a virtually unlimited array of shapes such as extruded tapes, cast as sheets or films, sealants such as gaskets and caulks, extruded or shaped profiles, stamped, among other configurations. The inventive-blend can also be die cut in accordance with copending and commonly assigned U.S. patent application Ser. No. 09/300,387, filed on Apr. 27, 1999 and entitled “Method and Apparatus for Die Cutting and Making Shaped and Laminate Articles”; the disclosure of which is hereby incorporated by reference. The inventive blend can be used for fabricate a laminate as described in U.S. Pat. No. 5,773,373, issued Jun. 30, 1998 and entitled “Reinforced Laminate With Elastomeric Tie Layer”; hereby incorporated by reference.

The blend can be employed: 1) in an expanded or unexpanded form as a sound abatement or sealant material for automotive or industrial applications, 2) as a tape or wrap for reducing pipeline corrosion, 3) cement, concrete or wood preservative, 4) as a component of a composite structure that is located or sandwiched between at least two metal layers thereby forming a so-called constraint layer damper, e.g., refer to U.S. Pat. No. 5,678,826 hereby incorporated by reference, among other uses. The inventive blend also be employed as a thixotropic/pumpable material (e.g., sealant), dispensed as a spray, two-part curable material (e.g., a two part reactive epoxy based system), among others. The inventive blend can be tailored to possess a desired chemical, physical strength, and temperature resistance e.g., from ambient to at least about 425F.

The blend is compatible with a wide range of surfaces. Examples of such surfaces comprise polymers such as polyvinyl chloride, metals such as steel, stainless steel, zinc containing surfaces such as galvanized metals, among other surfaces. The desirable characteristics of the inventive blend permit the blend to be applied upon a wet or damp surface, e.g., a metal pipe wet with condensing water. After being applied upon a suitable surface, if desired the inventive blend can be painted or over-coated.

The at least two polymers comprise a first polymer having a low viscosity (relative to a second polymer), and a second polymer having a relatively high viscosity. Examples of the first polymer can comprise at least one member selected from the group consisting of ethylene acrylics, ethylene functional polymers (e.g., EP rubbers, VAE and EVA), EPDM (e.g., Trilene® 65), ethylenepropylene (e.g., Trilene® CP80), grafted EPDM, EPDM functional polymers, styrene block copolymers (e.g., SIS, SBS and SEBS), nitrile functional rubbers, polyisobutylene based polymers (e.g., Kalar®, Vistanex®), ethylene acrylic (e.g., Vamac®), fluoro and perfluoropolymers sold commercially as Viton®, Kalrez®, Dai-el®, Technoflon® and Dyneon®; amorphous polyalphaolefins, amorphous polypropylene, among other polymers. Normally, the first polymer comprises EPDM. Examples of the second polymer can comprise at least one member selected from the group consisting of rubbers such as natural rubbers, acrylated or methacrylated polybutadiene, reactive liquid polymers such as Hycar®, polyacrylate, silicone, butadiene styrene, isoprene, epichlorohydrin, neoprene, hypalon, urethane, polysulfide, silicon grafted EPDM (e.g., Royaltherm®), fluoropolymers such as fluoroelastomers and perfluoroelastomers (e.g., Viton®, Kalrez®, among others), nitrile based polymers, styrene based polymers such as ABS, SBS, SIS, among others, ethylene-acrylic rubber (e.g., Vamac® and Therban®), among others. Normally, the total amount of first and second polymer ranges from about 5 to about 40 wt. % of overall polymeric blend.

The at least one resin can comprise at least one phenoxy resin, (e.g., Blox 200 polyether amine), bis-F epoxies, hydrocarbon resin esters,(e.g., Pentalyn K® or Pentalyn H®), at least one hydrocarbon resin including naturally occurring resins such as Gilsonite and bituminous materials. The amount of at least one resin ranges from about 5 to about 20 wt. % of the blend. The resin can comprise gilsonite and at least one phenoxy resin, epoxy functional or acrylic functional resin, among others. An inventive composition employing gilsonite and a phenoxy resin has improved temperature and flexibility. If desired, the blend can be substantially free of gilsonite and other bitumins. By “substantially free of bitumins” it is meant that the blend comprises less than about 10 wt. % and normally about 0 wt. % bitumins. Typically when a substantially bitumen free blend is desired, the resin will comprise at least one hydrocarbon resin ester (e.g., supplied commercially as Pentyaln® by Hercules).

The polymeric blend can also comprise a plasticizer (or liquid component) such as Ricon® 100, polybutadiene, among other plasticizers. In one specific aspect, the plasticizer as well-as the other components of the blend are substantially free of chloride, e.g., substantially free of chlorinated compounds. By “substantially free” it is meant that the polymeric blend contains less than about 10 wt. % and normally less than about 0 wt. % chloride or chlorinated compounds.,

In one aspect of the invention, at least one additive is present in the polymeric blend. Examples of suitable additives comprise at least one member from the group of a colorant/pigment, tackifier, filler, plasticizer, processing oil, surfactant, UV resistant materials, antimicrobial agents, flame retardants, among others. Virtually any additive can be incorporated so long as the additive does not adversely impact the processability or other composition characteristics. In one specific aspect, the additive comprises cubes or particulates. Particularly desirable results can be achieved by employing cubes comprising nylon 6/12, nylon 6/6 or other commercially available materials (e.g., 0.04/0.08/0.10 inch cubes available commercially from MaxiBlast). The cubes function as an in situ dampner or spacer that increases the compressive strength of the polymeric blend. When the blend is employed as a sealant, the cubes reduce the tendency of the sealant to be forced out of a seam or joint formed between two members being sealed, e.g., two metal members. That is, the cubes define the minimum distance between two members such that the sealant is retained in the joint. Normally, the amount of additive ranges from about 0.1 to about 5 wt. % of the blend.

In another specific aspect, the additive comprises at least one material that functions to passivate a metal surface thereby reducing the corrosion of the metal surface. Examples of suitable passivating materials can be found in U.S. Pat. Nos. 5,714,093, 6,010,094, 6,010,985 and 6,017,857; the disclosure of each of which are hereby incorporated by reference. Examples of passivating materials comprise at least one of sodium silicate, calcium silicate, potassium silicate, magnesium silicate, aluminum silicate, among other pH modifying or passivating materials. These passivating materials interact with corrosive agents such as water thereby reducing, if not eliminating, the impact of these agents, e.g., water penetrating the blend interacts with at least one silicate in the blend to form a high pH (e.g., about 9-10) environment in which a metal surface such as steel is not corroded. In an example of this aspect, the inventive composition comprises a blend that functions to passivate and impart acid resistance to an underlying metal containing substrate, e.g., a blend comprising a fluoropolymer (e.g., Viton®), gilsonite and at least one silicate (e.g., calcium silicate).

In a further specific aspect, the additive comprises at least one filler such as polyethylene, EVA, polypropylene, extreme pressure additives, among other powder or particulate plastics. The filler can also comprise at least one of iron oxide (e.g., 325 mesh magnetite), barium ferrite, strontium ferrite, metallic powders (e.g., iron, aluminum, zinc, among others), among other fillers. The amount of filler is selected to impart predetermined chemical and physical properties to the polymeric blend. Normally, the amount of filler comprises about 0.1 to about 80 wt. % of the blend.

In an aspect of the invention, the polymeric blend is extruded or otherwise applied onto a reinforcement. The reinforcement can be located upon or within the inventive blend, e.g., a sandwich structure or laminate structure. The reinforcement permits easier handling of the polymeric blend during application and/or manufacture, reduces flow (or sagging) when the blend is exposed to increased temperatures, increases tensile strength, improves abrasion resistance, among other characteristics. Depending upon the desired properties, e.g., temperature resistance, the reinforcement material can comprise any suitable material. The reinforcement material normally comprises a scrim, web, matte, mesh, perforated or un-perforated polymer films, or unwoven or woven assemblage. Depending upon the utility of the blend, when employing scrim the reinforcement material can have an open surface area of greater than 20 to at least about 80%. When the reinforcement material comprises a perforated polymer or metallic film, the reinforcement material can have an open surface area or porosity of about 1 to at least about 80%. The open surface area-of the reinforcement material provides support for the polymer blend while also permitting the blend to be self-sealing when being wrapped about a pipe. The open surface area also allows a reinforced blend to retain its flexibility. Examples of suitable reinforcement materials comprise fiberglass, polyproylene, polyethylene, Polyester, Flouropolymers, graphite, plastics, Kevlar®, aluminum, steel, copper, brass, cheesecloth, mixtures thereof, among other materials. Additional examples of reinforcement materials are described in U.S. Pat. No. 6,034,002, issued Mar. 7, 2000 and entitled “Sealing Tape For Pipe Joints”, and U.S. Pat. Nos. 5,120,381 and 4,983,449; each of the previous US patents are hereby incorporated by reference. Normally, the reinforcement material comprises a fiberglass scrim having generally round fibers and approximately 12 squares per inch. While the reinforcement material can have any suitable porosity or weave density (including less than about 20 wt. % open porosity), in most cases the porosity of the reinforcement material is such that the blend is self-adhering (or self-sealing). For example when employing the polymeric blend as a pipe wrap, the blend at least partially passes through the material in a manner sufficient for the blend to adhere to itself as the blend is being wrapped around the pipe, e.g., the blend passes through the reinforcement thereby permitting the blend to bond to itself. The self-adhering characteristic normally obviates the need for primers or pre-treatments, and increases the efficiency with which the blend covers a surface.

If desired, the reinforcement material can be coated or pretreated with an emulsion, UV reactive (including reactive to sunlight), water or solvent based systems, powder coat systems, or other composition for sizing the reinforcement material, e.g., the reinforcement material is coated with an emulsion for increasing the rigidity of the material thereby permitting the material to be cut to a predetermined size or configuration. The coating can be applied by any suitable methods known in the art such as dipping, laminating, spraying, roller coating, among others. Examples of suitable coatings for the reinforcement material comprise at least one of polyvinyl alcohol, ethylene vinyl acetate, acrylic, urethane or latex emulsions. Another example of a suitable coating for the reinforcement material comprises oligomers, monomers, additives, and a photo-initiator.

In another aspect of the invention, at least a portion of the blend can comprise a radiation activated or curable material. The source of the radiation can comprise UV, sunlight, electron beam, among other sources. Examples of suitable radiation curable materials are, disclosed in U.S. Pat. Nos. 6,057,382 and 6,174,932; the disclosure of which is hereby incorporated by reference. The radiation curing can be employed to form a self-supporting film upon the blend, increase the strength of a defined region (e.g., along the length of a sheet or tape), and strengthen the blend subsequent to installation, among other benefits.

In one specific aspect, shaped polymeric blend (with or without the reinforcement material) is laminated onto a colored or paintable film, e.g., a Mylar® film, pigmented/colored polyethylene film, among others. The laminated film can be continuous, perforated, and have a coating or release agent one side. Further examples of films and usage thereof can be found in U.S. Pat. No. 6,030,701 (issued on Feb. 29 2000) and entitled “Melt-Flowable Materials and Method of Sealing Surfaces”; hereby incorporated by reference.

In another aspect of the invention, a blowing or an expansion agent is added to the polymeric blend. The blowing agent is normally activated at an elevated temperature, e.g., about 325 F. While any suitable expansion agent can be employed examples of suitable agents comprise at least one member selected from the group consisting of Any suitable expansion or blowing agent can be employed such as azodicarbonamides and p,p′-oxybis(benzene-sulfonyl hydrazide) or diphenylozide-4, 4′-disulphohydrazides supplied, respectively, by Uniroyal as Celogen™ 765 and Celogen™ OT. In some cases, the aforementioned passivating agents can also be employed as an expansion agent. Typically, the expansion-agent comprises about 1 to about 15 wt. % of the composition prior to expansion. The amount of expansion agent can be tailored depending upon the temperature/time, desired degree of expansion, time permitted for expansion, among other parameters. Generally, higher concentrations of Celogen™ OT are employed in conjunction with urea (e.g., BIK OT supplied by Uniroyal Chemical Company) for relatively low temperature expansion whereas Celogen™ 765 accommodates higher temperature expansion. In some cases, the expansion or blowing agent has been treated. By treated it is meant that the expansion or blowing agent has been contacted or admixed with a naphthenic binder. For example, an expansion agent comprising Celogen™ OT has been admixed with a naphtheninc binder for safety and dispersion. Examples of suitable binders comprise those supplied by Polychem, PPD celot 90, ElastoChem, OT-72 AkroChem, and mixtures thereof.

Moreover, the expansion or blowing agent can be encapsulated within a shell. That is, a liquid or gaseous blowing agent is combined with or encapsulated within a thermoplastic particle or powder, e.g., a hydrocarbon encapsulated within an acrylonitrile shell as Expancel® that is supplied by Expancel Inc., a division of Akzo Nobel Industries. For example, the shells can be fabricated from polyolefins such as polyethylene and polypropylene; vinyls, EVA, nylon, acrylics, among other materials. The shells can also comprise a distribution of differing particle sizes, composition and activation temperatures. Specific examples of suitable encapsulated blowing agents comprise at least one member selected from the group of hydrocarbons such as isobutane and isopentane; fluorocarbons such as 1-1dichloroethene, HFC-134a, HFC-152a; and nitrogen releasing chemical blowing agents such as those supplied as Celogen® by UniRoyal that are encapsulated within any suitable thermoplastic, e.g., 2-methyl 2-propenioc acid methyl ester polymer with 2-propenenitrile and vinylidene chloride polymer and polyvinylidene fluoride. These materials are supplied commercially by Expancel, Inc., a division of Akzo Nobel as Expancels® 051WU, 051DU, 091DU80, 820WU, 820DU, 642WU, 551WU, 551 WU80, 461 DU or Micropearl® F30D supplied by Pierce and Stevens. These materials can be supplied in either dry or wet form. These materials can also be coated with any suitable material for controlling the activation temperature of the encapsulated blowing agents. An example of a coating comprises an acrylated materials, waxes, among other materials.

In a further aspect of the invention, at least one cross-linking material can be present in the blend. If utilized, the amount of at least one cross-linking material comprises about 0.1 to about 25 wt. % of the blend. Normally, the cross-linking material will be activated by an external source such as elevated temperature, a source of radiation (e.g., laser, UV, sunlight, or electron beam), among other conventional methods for activating a polymer cross-linker. While any suitable material can be used, examples of suitable materials comprise at least one of sulfur curing compounds, peroxides, free radical compounds, acid functional compounds, stearic acid, tetramethylthiuram disulfide, e.g., TMTD applied by Akrochem Corporation, Akron, Ohio, organic peroxide by AkroChem, and Urea (surface treated), e.g., BIK-OT by Uniroyal Chemical Company, among other conventional cross-linking or curing agents. The cross-linking agent can comprise a material that is encapsulated or polymer bound within another material, e.g, imidazoles and polymer bound imidazoles such as Intelimer® 7004, 7024, and 7124 supplied by Landec. The presence of at least one cross-linking agent permits applying the inventive blend (with or without reinforcement) upon a surface such as a pipe, and then curing the blend thereby forming a self-supporting layer upon the surface.

In another aspect of the invention, the composition comprises a thixotropic gel. The gel can be applied upon a metal containing surface, similar to the aforementioned tape, for reducing metal corrosion. The temperature, chemical resistance, among other properties of the gel can be tailored. The gel can be applied as a heated blend, with a caulk gun, troweled, among other conventional application methods. The gel normally comprises at least one polymer, at least one resin, at least one passivating material and at least one additive. Examples of suitable polymers comprise at least one member from the group comprising EPDM (e.g., Trilene® 65), ethylenepropylene (e.g., Trilene® CP80), butyl based polymers (e.g., Kalar®, Vistanex®), ethylene acrylic (e.g., Vamac®), fluoro and perfluoropolymers such as those supplied commercially as Viton®, Kalrez®, Dai-el®, Technoflon® and Dyneon®; amorphous polyalphaolefins, amorphous polypropylene, among other polymers. Examples of suitable resins comprise at least one member from the group comprising bituminous resins, such as gilsonite, hydrocarbon resins, epoxy resins, phenoxy resins, among others. The resin utilized is dependent upon the temperature to which the blend will be exposed, e.g., the melt point of the resin is greater than the exposure temperature. Examples of suitable passivating materials comprise calcium silicate, sodium silicate, potassium silicate, magnesium silicate, aluminum silicate, magnesium-aluminum silicate, sodium magnesium aluminosilicate (e.g. Hydrex® supplied by Huber), mixtures thereof, among others. Examples of suitable additives comprise at least one member from the group of fillers, surfactants, pigments, among other materials. When a filler is employed, examples of suitable fillers comprise plastic powders (e.g., polyethylene, polypropylene, ethylene vinyl acetate, among others), metal powders (e.g., iron, aluminum, zinc, among others), among other fillers. In general, fillers usually comprise about 1 to about 50 wt. % of a gel, polymers about 15% to about 80 wt % and surfactants/stabilizers/pigments, coupling agents such, as silanes, titanates, zirconates, among others) about 0.1% to about 5 wt. % of the inventive gel composition. In general, the inventive blend can be employed as a tape or gel depending upon polymer selection and the amount of filler and/or resin present.

As described above, the inventive blend can be employed as a pipe wrap for imparting improved corrosion resistance to the pipe (the tape can also be tailored to accommodate relatively high temperature pipes (e.g., 425F)). Such pipes are typically employed in arrays or racks. When the spacing between pipes is relatively small, the inventive blend can be employed to reduce pipe vibration, frictional pipe wear caused by vibration, among other pipe contact related problems. If desired, the outer surface of the inventive pipe wrap can be employed with a spacer or wear surface such as a high molecular weight polymer, e.g., two adjacent pipes are wrapped with the inventive tape and the exterior portion of each tape includes a polymeric wear surface. The wear surfaces of adjacent pipes are in contact. The wear surface allows the pipes to vibrate without damaging either the pipes or inventive pipe wrap.

The inventive blend can also be employed as a vehicular sealant, e.g., automobiles, golf cars, industrial equipment, among other on-off road vehicles. The blend as a sealant can be located along battery box frames, motor mounts, cross-member support brackets, among other areas wherein it is desirable to provide an environmental barrier (e.g., road debris, water and salt). In addition to providing an environmental barrier, the inventive blend comprises at least one passivating agent thereby permitting the inventive blend to enhance the corrosion resistance of an adjoining metal surface. In contrast to conventional tapes, the inventive blend can withstand temperatures associated with conventional wire welding.

The inventive blend is normally applied onto a release film or liner such as wax coated or silicone treated, paper, polyethylene, among other conventional disposable materials. The release film is normally removed just prior to applying the blend onto a desired surface, e.g., pipe. After applying the blend upon the desired surface, the release film or liner can be removed and reapplied upon the blend in order to protect the applied blend, e.g., the release film can comprise a one side coated plastic film and employed to wrap the applied blend with the uncoated side to order to impart improved abrasion resistance. The release film can also comprise the aforementioned perforated films.

The abrasion resistance of the blend can also be improved by employing a blend having a thermosetting matrix (with or without the aforementioned reinforcement). A thermosetting blend can be applied upon a desired surface such as a pipeline and exposed to an amount of heat sufficient to cure the thermosetting matrix. Heat can be supplied by using conventional means such as flame, radiant heating, among others. Depending upon the desired curing agent, the curing agent can be activated at room temperatures to about 400F. Alternatively, the inventive blend can be employed as a two part system wherein the two parts remain uncured until combined. If desired, the thermosetting matrix can be expanded by employing a suitable expansion agent.

While the inventive blend can be fabricated in a wide range of sizes and shapes, when employing the inventive blend as a tape it may be desirable to use the tape in lengths of eight (8) to twelve (12) feet for ease of handling the release liner. The inventive blend can also be die cut or other wise shaped into curvilinear designs, strips, among other configurations.

If desired, the inventive blend can be high temperature resistant. By “high temperature resistant”, it is meant that the blend has less than about 15 wt. % loss when exposed to a temperature of about 425 F for a period of 48 hours. The high temperature resistance, permits using the inventive blend upon heated pipelines, automotive engine compartments, among other environments.

While the above description places particular emphasis on tapes and gels for reducing pipeline corrosion, the inventive blends can be employed in a wide range of end uses. Examples of such uses comprise window sash sealing, expansion joints including bridge expansion joints, door sash and threshold sealant, concrete sealant, concrete expansion joint, HVAC duct wrapping, gasket, furnace flue sealant, battery box liner, protecting metallic joints and seams (including automotive welds) and crevices from corrosion, wire rope protectant, among other uses.

The following Examples are provided to illustrate certain aspects of the invention and not to limit the scope of any appended claims. Unless indicated otherwise, percent or weight refers to weight percentage.

### EXAMPLE 1

The following Table illustrates a polymeric blend of the invention. The Table provides a range of materials as well as one specific Example (“In Parts”). The Example In Parts was obtained by blending the raw materials in a double arm lab mixer. Royaltherm®, and Hubersorb® 600 were added to the mixer and blended to a substantially uniform mixture (approximately 15 minutes). Paphen® 200, zinc oxide, Ricon® 100 and lithium stearate were then added and mixing was continued until a substantially uniform mixture was obtained (approximately 10 minutes). A mixing temperature of about 125F was measured. The mixed materials were removed from the mixer and added to a single screw extruder to form a 3 inch×0.040 inch strip. The extruded strip was coated with a fiberglass scrim and rolled.

The rolled blend was applied around the exterior surface a steel pipe for imparting high temperature corrosion resistance. The steel pipe was then exposed to a temperature of at least about 285-300F with cyclic exposure to 600F.

TABLE

| | Descrip- | Wt. % | Actual in | |
|---|---|---|---|---|
| Raw Material | tion | Range | Parts | Supplier |
| Trilene 65 | Polymer | 35-40 | 150 | Uniroyal |
| Royaltherm 1411 | Polymer | 5-8 | 30 | Uniroyal |
| Gilsonite Hi | resin | 6-8 | 25 | American Gilsonite/ |
| Temp | | | | Lexco/Zeigler |
| Gilsonite multi | resin | 6-8 | 25 | American Gilsonite/ |
| | | | | Lexco/Zeigler |
| Paphen 200 | resin | 3-6 | 30 | Phenoxy |
| | | | | Assoc. |
| Ricon 100 | poly | 12-15 | 50 | Ricon Resins |
| | plasticizer | | | |
| Hubasorb 600 | Calcium | 12-15 | 50 | Huber |
| | silicate | | | |
| Zinc oxide | pigment | .5-1 | 5 | Zochem |
| Lithium stearate | surfactant | .5-1 | 5 | Whitco |

Trilene® 65 has a viscosity of about 100,000 cP at 70C, Royaltherm® 1411 has a Mooney ML1 at 125C, Gilsonite Hi Temp has a melt point of about 225C, Gilsonite multi has a melt point of about 173C, Paphen® has a meltpoint of about 195C, Ricon® 100 has a viscosity of 7,500 cP at 25C; and Hubasorb® 600, zinc oxide and lithium stearate are all solids under ambient conditions.

Examples 2 through 5 illustrate compositions that were fabricated into tapes, e.g., for pipe wraps for imparting corrosion resistance. Example 2 illustrates a tape of a temperature resistance of at least about 325F, Example 3 an ambient temperature tape, Example 4 a tape having a temperature resistance of at least about 425F and Example 5 illustrates an alternative ambient temperature tape. A method for making the tapes of Examples 2 through 5 is described in Example 2.

EXAMPLE 2

| A | B | C | D | E | F |
|---|---|---|---|---|---|
| Component | Description | Wt. % | Actual | Viscosity | Supplier |
| Trilene 65 | Ethylene Propylene | 35-40 | 150 | 100,000 cP @ 70 C | Uniroyal |
| | Elastomer | | | | |
| Royaltherm 1411 | Silicone Grafted Ethylene | 5-8 | 30 | Mooney ML1 @ 125 C (25) | Uniroyal |
| | Propylene Polymer | | | | |
| Gilsonite Hi Temp | Resin | 6-8 | 25 | 225 C meltpoint | American Gilsonite/ |
| | | | | | Lexco/Zeigler |
| Gilsonite multi | Resin | 6-8 | 25 | 173 C meltpoint | American Gilsonite/ |
| | | | | | Lexco/Zeigler |
| Paphen 200 | Resin | 3-6 | 30 | 195 C meltpoint | Phenoxy Assoc. |
| Ricon 100 | poly plasticizer | 12-15 | 50 | 7500 cP @ 25 C | Ricon Resins |
| Hubasorb 600 | Passivating | 12-15 | 50 | Solid | Huber |
| | Filler | | | | |
| Zinc oxide | Pigment | .5-1 | 5 | Solid | Zochem |
| Lithium stearate | Surfactant | .5-1 | 5 | Solid | Whitco |

The components of the composition listed in column D was blended in a double arm lab mixer. Column C lists the range of Components that can be effectively used in making the composition. Royaltherm ®, Trilene ® 65, and Paphen ® phenoxy resin, zinc oxide, Ricon ®, and lithium stearate were then added and mixing was resumed to obtain a homogeneous blend (10 minutes). A batch temperature of 125 F was observed.
The material was removed, and processed in a single screw extruder to form 3″ X .040″ X 120″ strips The strips were coated with fiberglass scrim (Loose weave) and rolled.

The rolled strips of blended polymer on fiberglass scrim reinforcement can be employed by wrapping around a pipe or pipe flange. The rolled strips can be applied under insulation, or to exposed pipe with minimal pipe surface preparation, and painted if desired. This material can be extruded into profiles or a variety of die cut shapes.

The following Table lists certain Physical Characteristics of the reinforced strips. These Physical Characteristics were determined in accordance with conventional practices.

| Physical Characteristics | Results |
|---|---|
| Specific Gravity: | 1.0-1.2 |
| Water Absorption | <1% |
| Consistency (ASTM D217) | 9.2-10 mm @ 70° F. |
| 300 g load | 3.5-4.3 mm @ 0° F. |
| Color: | Brown |
| Storage Stability: | 12 months from receipt |
| Corrosion (1000 Hours): ASTM B 117 | No loss of adhesion |
| | No corrosion |
| Cold Flexibility (0° F. 45° bend) | No loss of adhesion |
| | No cracking |

EXAMPLE 3

| A | B | C | D | E | F |
|---|---|---|---|---|---|
| Raw Material | Description | Wt. % | Actual | Viscosity | Supplier |
| Sylvatac 5N | Long Chain Hydrocarbon | 37.03704 | 100 | 100,000 cP @ 70 C | Arizonia |
| | Resin | | | | |
| Vistanex LMMH | Polyisobutylene | 11.11111 | 30 | Ms 12000 | Exxon |
| Gilsonite multi | Resin | 18.51852 | 50 | 173 C meltpoint | American Gilsonite/ |
| | | | | | Lexco/Zeigler |
| Ricon 184 | Polybuta Diene | 11.11111 | 30 | 7500 cP @ 25 C | Ricon Resins |
| Hubasorb 600 | Passivating | 18.51852 | 50 | Solid | Huber |
| | Filler | | | | |
| Zinc oxide | Pigment | 1.851852 | 5 | Solid | Zochem |
| Lithium stearate | Surfactant | 1.851852 | 5 | Solid | Whitco |
| | | | | 270 | |

EXAMPLE 4

| Raw Material | Description | Wt. % | Actual | Viscosity | Supplier |
|---|---|---|---|---|---|
| Trilene 65 | Polymer | 35-40 | 150 | 100,000 cP @ 70 C | Uniroyal |
| Viton A100 | Polymer | 5-8 | 30 | Mooney ML1 @ 125 C (25) | DuPont |
| Gilsonite Hi Temp | Naturally Occurring | 6-8 | 25 | 225 C meltpoint | American Gilsonite/ |
| | Hydrocarbon Resin | | | | Lexco/Zeigler |
| Gilsonite multi | Naturally Occurring | 6-8 | 25 | 173 C meltpoint | American Gilsonite/ |
| | Hydrocarbon Resin | | | | Lexco/Zeigler |
| Paphen 200 | Phenoxy | 3-6 | 30 | 195 C meltpoint | Phenoxy Assoc. |
| Ricon 100 | poly plasticizer | 12-15 | 50 | 7500 cP @ 25 C | Ricon Resins |
| Hubasorb 600 | Passivating | 12-15 | 50 | Solid | Huber |
| | Filler | | | | |
| Zinc oxide | Pigment | .5-1 | 5 | Solid | Zochem |
| Lithium stearate | Surfactant | .5-1 | 5 | Solid | Whitco |
| | | | | 370 | |

The rolled strips of blended polymer on fiberglass scrim reinforcement can be employed by wrapping around a pipe or pipe flange. The rolled strips can be applied under insulation, or to exposed pipe with minimal pipe surface preparation, and painted if desired. This material can be extruded into profiles or a variety of die cut shapes.

The following Table lists certain Physical Characteristics of the reinforced strips. These Physical Characteristics were determined in accordance with conventional practices.

| Physical Characteristics | Results |
|---|---|
| Specific Gravity: | 1.0-1.1 |
| Water Absorption | <1% |
| Consistency (ASTM D217) | 14-15 mm @ 70° F. |
| 300 g load | 5.2-5.7 mm @ 0° F. |
| Color: | Brown |
| Storage Stability: | 12 months from receipt |
| Corrosion (1000 Hours): ASTM B 117 | No loss of adhesion |
| | No corrosion |
| Cold Flexibility (0° F. 45° bend) | No loss of adhesion |
| | No cracking |

EXAMPLE 5

| Raw Material | Description | Wt. % | Actual | Viscosity | Supplier |
|---|---|---|---|---|---|
| Kalar 5245 | Butyl Rubber | 3.225806 | 9 | Mooney | Hardman |
| | | | | ML1 @ 125 C (30) | |
| Sylvatac 5N | Polymer | 35.84229 | 100 | 100,000 cP @ 70 C | Arizonia |
| Vistanex | Polymer | 10.75269 | 30 | Ms 12000 | Exxon |
| LMMH | | | | | |
| Gilsonite multi | Resin | 17.92115 | 50 | 173 C meltpoint | American Gilsonite/ |
| | | | | | Lexco/Zeigler |
| Ricon 184 | poly plasticizer | 10.75269 | 30 | 7500 Cp @ 25 C | Ricon Resins |
| Hubasorb 600 | Passivating | 17.92115 | 50 | Solid | Huber |
| | Filler | | | | |
| Zinc oxide | Pigment | 1.792115 | 5 | Solid | Zochem |
| Lithium stearate | Surfactant | 1.792115 | 5 | Solid | Whitco |

The rolled strips of blended polymer on fiberglass scrim reinforcement can be employed by wrapping around a pipe or pipe flange. The rolled strips can be applied under insulation, or to exposed pipe with minimal pipe surface preparation, and painted if desired. This material can be extruded into profiles or a variety of die cut shapes.

The following Table lists certain Physical Characteristics of the reinforced strips. These Physical Characteristics were determined in accordance with conventional practices.

| Physical Characteristics | Results |
|---|---|
| Specific Gravity: | 1.0-1.2 |
| Water Absorption | <r % |
| Consistency (ASTM D217) | 16-19 mm @ 70° F. |
| 300 g load | 5.0-6.3 mm @ 0° F. |
| Color: | Brown |
| Storage Stability: | 12 months from receipt |
| Corrosion (1000 Hours): ASTM B 117 | No loss of adhesion |
| | No corrosion |
| Cold Flexibility (0° F. 45° bend) | No loss of adhesion |
| | No cracking |

If desired, the tapes could be fabricated by extruding multiple tape strips and coating the fiberglass reinforcement material with polyvinyl alcohol, ethylene vinyl acetate, emulsions such as urethane or latex. By coating the reinforcement material, the material binds more readily to the polymeric blend, improves cutting the material to size and reduces fraying when employing a fiberglass reinforcement material.

The following formulations listed in Examples 6 through 8 can be employed as a thixtropic gel. These gels could be applied with or without an abrasion resistant wrapping such as vinyl, polyester, polyethylene, flouroelastomer film or weave, geotextiles are another commonly used wrapping material. Examples 6 through 8 refer to thixotropic gel formulations having tailored temperature resistance. The gel of Example 6 can be exposed to a temperature of about 425F for a period of about 6 months and continue to be effective at reducing the corrosion rate of the underlying metal surface, the gel of Example 7 is resistant to a temperature of about 325° F. and the gel of Example 8 is resistant to 225° F. The gels of Examples 6 through 8 were formed by being blended in double arm sigma mixer. If desired, commercially available high shear, high torque mixing equipment can be utilized.

| | | | | | |
|---|---|---|---|---|---|
| Raw Material | Description | Wt. % | Actual | Viscosity | Supplier |

EXAMPLE 6

| | | | | | |
|---|---|---|---|---|---|
| Trilene CP 80 | Polymer | 25-35 | 150 | 100,000 cP @ 70 C | Uniroyal |
| Viton A100 | Polymer | 5-8 | 30 | Mooney | DuPont |
| | | | | ML1 @ 125 C (25) | |
| Gilsonite Hi | Naturally Occurring | 4-8 | 25 | 225 C meltpoint | American Gilsonite/ |
| Temp | Hydrocarbon Resin | | | | Lexco/Zeigler |
| Gilsonite multi | Naturally Occurring | 4-8 | 25 | 173 C meltpoint | American Gilsonite/ |
| | Hydrocarbon Resin | | | | Lexco/Zeigler |
| Paphen 200 | Phenoxy | 5-8 | 30 | 195 C meltpoint | Phenoxy Assoc. |
| Ricon 134 | poly plasticizer | 25-35 | 150 | 5500 cP @ 25 C | Ricon Resins |
| Hubasorb 600 | Passivating | 10-15 | 50 | Solid | Huber |
| | Filler | | | | |
| Zinc oxide | Pigment | .5-1 | 5 | Solid | Zochem |
| Lithium stearate | Surfactant | .5-1 | 5 | Solid | Whitco |

EXAMPLE 7

| | | | | | |
|---|---|---|---|---|---|
| Vamac G | Polymer | 8-10 | 30 | 150,000 cP @ 100 C | Dupont |
| Trilene CP 80 | Polymer | 35-45 | 150 | 100,000 cP @ 70 C | Uniroyal |
| Gilsonite Hi | Naturally Occurring | 5-8 | 25 | 225 C meltpoint | American Gilsonite/ |
| Temp | Hydrocarbon Resin | | | | Lexco/Zeigler |
| Gilsonite multi | Naturally Occurring | 5-8 | 25 | 173 C meltpoint | American Gilsonite/ |
| | Hydrocarbon Resin | | | | Lexco/Zeigler |
| Ricon 134 | poly plasticizer | 10-15 | 50 | 7500 cP @ 25 C | Ricon Resins |
| Hubasorb 600 | Passivating | 10-15 | 50 | Solid | Huber |
| | Filler | | | | |
| Zinc oxide | Pigment | .5-1 | 5 | Solid | Zochem |
| Lithium stearate | Surfactant | .5-1 | 5 | Solid | Whitco |

EXAMPLE 8

| | | | | | |
|---|---|---|---|---|---|
| Vistanex | Polymer | 35-40 | 150 | 100,000 cP @ 70 C | Exxon |
| LMMS | | | | | |
| Gilsonite Hi | Naturally Occurring | 5-8 | 25 | 225 C meltpoint | American Gilsonite/ |
| Temp | Hydrocarbon Resin | | | | Lexco/Zeigler |
| Gilsonite multi | Naturally Occurring | 5-8 | 25 | 173 C meltpoint | American Gilsonite/ |
| | Hydrocarbon Resin | | | | Lexco/Zeigler |
| Sylvatac 5N | Hydrocarbon | 35-45 | 150 | | |
| | resin | | | | |
| Ricon 100 | poly plasticizer | 10-15 | 50 | 7500 cP @ 25 C | Ricon Resins |
| Hubasorb 600 | Passivating | 10-15 | 50 | Solid | Huber |
| | Filler | | | | |
| Zinc oxide | Pigment | .5-1 | 5 | Solid | Zochem |
| Lithium stearate | Surfactant | .5-1 | 5 | Solid | Whitco |

### EXAMPLE 9

A tape formed in accordance with Example 7 was evaluated to ascertain whether or not it was compatible with conventional cathodic pipe protection. The pipe wrap was tested in accordance with ASTM G8-96 method “A”.

A. Method of Test (Cathodic Disbondment)

Two separate tests were performed:

Test 1—The black iron pipe was sandblasted clean before the application of the tape.

Test 2—The black iron pipe was sandblasted clean and then rusted in a neutral salt spray cabinet for 24 hours. The pipe was removed from the salt spray, dried off and rubbed down with paper towels to remove the scale before applying the tape.

Tape formulated for use up to 325 degrees F was used for these tests. The intentional holidays were 0.25 in diameter. The time duration of the test was 30 days.

B. Results of Test

Test 1—Clean Pipe

Cohesive separation of the tape adjacent to the holidays. No apparent disbonding. The reference voltage at the end of the test was −1.54 volts.

Test 2—Pre-Rusted Pipe

Adhesive separation of the tape from the pipe. The pipe was damp and the color of the pipe has darkened. There is no rust present around the holiday, the tape appears to have bonded to the rusty surface of the pipe thus creating the adhesive type separation. The reference voltage at the end of the test was −1.54 volts.

### EXAMPLES 10 AND 11

Examples 10 and 11 illustrate blends of the instant invention that cure and provide improved resistance to abrasion resistance (e.g., to soil when employed to protect underground pipelines), cathodic disbondment and improved strength. These blends can be employed as tapes for wrapping above or below ground pipelines.

The blends of Examples 10 and 11 were prepared in a 40 gal batch Baker Perkins sigm mixer in accordance with the following steps:

Step 1.

Add base polymer (viton, vamac, or polyisobutylene polymer) 30 lbs.

Add 25 lbs of Hubersorb® 600

Add 50 lbs of Trilene® CP 80 (can substitute Trilene® 65 if desired)

Mix added materials until homogenous.

Step 2

Add 25 lbs Hubersorb® 600

Add 50 Lbs. of Trilene® CP 80

Mix added materials until homogenous

Step 3

Add gilsonite resin

Add 50 lbs. of Trilene® CP 80

Mix added materials until homogenous

Step 4

Add remaining raw materials and mix until homogeneous

EXAMPLE 10

| Raw Material | Description | Wt. % | Actual | Viscosity | Supplier |
|---|---|---|---|---|---|
| Trilene CP 80 | Polymer | 25-35 | 150 | 100,000 cP @ 70 C | Uniroyal |
| Viton A100 | Polymer | 5-8 | 30 | Mooney | DuPont |
| | | | | ML1 @ 125 C (25) | |
| Gilsonite Hi | Naturally Occurring | 4-8 | 25 | 225 C meltpoint | American Gilsonite/ |
| Temp | Hydrocarbon Resin | | | | Lexco/Zeigler |
| Gilsonite multi | Naturally Occurring | 4-8 | 25 | 173 C meltpoint | American Gilsonite/ |
| | Hydrocarbon Resin | | | | Lexco/Zeigler |
| Paphen 200 | Phenoxy | 5-8 | 30 | 195 C meltpoint | Phenoxy Assoc. |
| Ricon 100 | poly plasticizer | 2.5-5 | 30 | 5500 cP @ 25 C | Ricon Resins |
| Hubasorb 600 | Passivating | 10-15 | 50 | Solid | Huber |
| | Filler | | | | |
| Zinc oxide | Pigment | .5-1 | 5 | Solid | Zochem |
| Lithium stearate | Surfactant | .5-1 | 5 | Solid | Whitco |
| Shell SU 2.5 | Epoxy resin | 20-30 | 120 | Liquid | Shell |
| DiCyandiamide | Epoxy curing agent | 1-5 | 2.4 | Powder | CVC specialties |

EXAMPLE 11

| | | | | | |
|---|---|---|---|---|---|
| Trilene CP 80 | Polymer | 25-35 | 150 | 100,000 cP @ 70C | Uniroyal |
| Viton A100 | Polymer | 5-8 | 30 | Mooney | DuPont |
| | | | | ML1 @ 125C (25) | |
| Gilsonite Hi | Naturally Occurring | 4-8 | 25 | 225 C meltpoint | American Gilsonite/ |
| Temp | Hydrocarbon Resin | | | | Lexco/Zeigler |
| Gilsonite multi | Naturally Occurring | 4-8 | 25 | 173 C meltpoint | American Gilsonite/ |
| | Hydrocarbon Resin | | | | Lexco/Zeigler |
| Paphen 200 | Phenoxy | 5-8 | 30 | 195 C meltpoint | Phenoxy Assoc. |
| Ricon 100 | poly plasticizer | 2.5-5 | 30 | 5500 cP @ 25 C | Ricon Resins |
| Hubasorb 600 | Passivating | 10-15 | 50 | Solid | Huber |
| | Filler | | | | |
| Zinc oxide | Pigment | .5-1 | 5 | Solid | Zochem |
| Lithium stearate | Surfactant | .5-1 | 5 | Solid | Whitco |
| Shell SU 2.5 | Epoxy resin | 20-30 | 120 | Liquid | Shell |
| DiCyandiamide | Epoxy curing agent | 1-5 | 2.4 | Powder | CVC specialties |
| Intellemer 7024 | Epoxy curing agent | 1-5 | .4 | Powder | Landec |

### EXAMPLES 12 AND 13

Examples 12 and 13 illustrate blends of the instant invention that employ at least one cross-linking material that is heat activated. These blends have enhanced resistance to abrasion, corrosion and cathodic disbondment. The amounts given below are in parts. These blends were combined by using a double arm mixer and the following steps:

1) Add elastomer(s) and solid epoxy resin(s): Blend until the mix is homogeneous

2) Incrementally add liquids and filler: Blend until the mix is homogeneous, and;

3) Add curing agent(s) and blend until the mix is homogeneous. For best results, the batch temperature prior to adding the curing agents is below 180 F.

The following Table lists the components employed in preparing the blends, its resistance to fuel, and results of a cathodic disbondment test.

| | Example | |
|---|---|---|
| | 12 | 13 |
| Epon 834 | 165 | 200 |
| Epon 828 | | 150 |
| Epon 1002F | 15 | |
| Epon 1001F | | 150 |
| Epon 58005 | 60 | |
| Nipol 1312 | | 50 |
| Nipol 1000 × 132 | | 75 |
| Elvaloy AS | 57 | |
| Elvax 205 W | 18 | |
| HM 443 | 650 | |
| Gilsonite Multipurpose | | 200 |
| Erisys DDA10 | 18 | 39.5 |
| Varox DBPH-50 | | 10 |
| Specific Gravity | ≃2.2 ± 0.1 | 0.96 |
| 3-Point Flex Strength | | |
| (Modified ASTM D790)**: | | |
| Cure at 350 F for 20 mins: | | |
| Load (lbs) | 54-58 | 70 |
| Displ (in) | 0.6 | 0.56 |
| t (mm) | 1.30 | 1.38 |
| 72 hr Diesel Fuel Soak | No swelling, | no swelling, blistering, |
| | blistering, or | or other noticeable |
| | other noticeable | afafects |
| | affects | |
| Cathodic Disbondment | Material Only | Material Only Not Tested |
| Test*** | Pass | |
| | Material with | Material with |
| | Fiberglass | Fiberglass Cloth Pass |
| | Cloth Pass | Material with Mylar ® |
| | Material with | (1.5 mil PET 1 side) Pass |
| | Mylar ® | |
| | (1.5 mil PET | |
| | 1 side) Pass | |

**Cross head speed is 0.5 in/minute, the span is 4 inches, and the support and load bars diameter is 0.5 inch, the steel substrate measured 1 × 6 × 0.031 inch and sample dimension 1 × 6 × listed thickness.
***The tape was wrapped around a steel pipe and heated to a temperature of about 400° F. for approximately 20 minutes.

The following Table lists the components that were employed to prepare the blends of Examples 12 and 13.

| Raw Material | Description | Supplier |
|---|---|---|
| Erisys DDA10 | Dicyandiamide | CEMSAC/CVC |
| | | Specialty Chemicals |
| Varox DBPH-50 | Peroxide Cure | R. T Vanderbilt |
| Elvax 205W | EVA | DuPont |
| Gilsonite | Hydrocarbon Resin | Lexco |
| Multipurpose | | |
| HM 443 | Strontium Ferrite | Hoosier Magnetics |
| | Metal Powder | |
| Elvaloy AS | Ethylene-Acrylic Copolymer | DuPont |
| Epon 1001F | Bis A Epoxy | Walsh & Assoc/Shell |
| Epon 1002F | Bis A Epoxy | Walsh & Assoc/Shell |
| Epon 58005 | Bis A Rubber | Walsh & Assoc/Shell |
| | Modified Epoxy | |
| Epon 828 | Bis A Epoxy | Walsh & Assoc/Shell |
| Epon 834 | Bis A Epoxy | Walsh & Assoc/Shell |
| Nipol 1000 × 132 | Nitrile Rubber | Zeon Chemicals |
| Nipol 1312 | Nitrile Rubber | Zeon Chemicals |

The following is claimed:

1). A composition comprising a combination comprising at least one polyisobutylene polymer, at least one resin, gilsonite, and at least one filler.

2). A composition comprising a combination comprising at least one member selected from the group of ethylene acrylics, fluoropolymers, ethylene functional polymers, grafted EPDM, EPDM functional polymers, styrene block copolymers, and nitrile functional rubbers, at least one bitumin, and at least one passivating agent.

3). A high temperature resistant composition comprising a combination comprising at least one polymer, gilsonite, and at least one silicate.

4). The composition of claim 2 wherein the polymer comprises EPDM.

5). The composition of claim 1 wherein the filler-comprises at least one silicate.

6). The composition of claim 2 wherein said polymer comprises at least one EPDM functional polymer, said bitumin comprises gilsonite and said passivating agent comprises at least one silicate.

7). The composition of claim 3 wherein said silicate comprises calcium silicate.

8). The composition of claim 6 wherein said at least one silicate comprises calcium silicate.

9). The composition of claim 5 wherein said at least one silicate comprises calcium silicate.

10). The composition of claim 3 wherein said polymer comprises at least one member selected from the group consisting of epoxy functional, hydroxyl functional and acrylic functional polymers.

11). The composition of claim 10 further comprising ethyl vinyl acetate.

12). The composition of claim 1 further comprising at least one reinforcement.

13). The composition of claim 2 further comprising at least one reinforcement.

14). The composition of claim 3 further comprising at least one reinforcement.

15). The composition of claim 2 further comprising a film upon at least a portion of one surface of said composition.

16). The composition of claim 2 further comprising at least one expansion agent.

17). The composition of claim 2 further comprising at least one thermosetting compound and at least one curing agent for said compound.

18). The composition of claim 2 wherein said polymer comprises at least one radiation curable polymer and at least one photo-initiator.

19). Use of the composition of claim 1 as a pipeline protectant.

20). Use of the composition of claim 3 as an automotive sealant.
